(19) United States
(12) Patent Application Publication
(10) Pub. No.: US 2005/0114841 A1
(43) Pub. Date: May 26, 2005

(54) Automatic computer code review tool

(76) Inventors: Milton E. Moskowitz, Peoria, AZ (US); William F. Potter, Waddell, AZ (US); Wayne A. King, Glendale, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/769,535

(22) Filed: Jan. 30, 2004

Related U.S. Application Data
(60) Provisional application No. 60/523,934, filed on Nov. 21, 2003.

(51) Int. Cl. G06F 9/44

(52) U.S. Cl. 717/126

(57) ABSTRACT

A method for automatically reviewing the source code for a system where the source code is generated automatically from a model of the system is provided. In a first step, the model is read in and processed to determine the expected computer code based on the model. Next, the generated source code is read in. The generated source code is compared to the expected source code to determine if the generated source code includes all the elements of the expected source code.

### CROSS REFERENCE TO RELATED APPLICATIONS

This application claims the benefit of provisional application 60/523,934 filed on Nov. 21, 2003 and entitled “Automatic Computer Code Review Tool”.

### FIELD OF THE INVENTION

This invention relates to the field of computer programming and more specifically to an automatic computer code review tool.

### BACKGROUND OF THE INVENTION

Software to operate and control complex systems is often first modeled and developed using a modeling tool. Once a simulation model of the system is created, computer code based on the model can be generated. The computer code can be generated manually, such as by a programmer developing the computer code based on the simulation model, or automatically using specialized tools. For efficiency and accuracy reasons, automated code generating tools are starting to be used more frequently.

For example, avionic control systems can be modeled by using the commercially available program SIMULINK, developed by MathWorks of Natick, Mass., to model the system. The SIMULINK program, which runs in conjunction with the mathematical analysis tool MATLAB, also developed by MathWorks, can be used to model and develop control systems, signal processing systems and the like. The SIMULINK program a simulation and prototyping software. Models for simulating and analyzing real-world dynamic systems can be developed using the SIMULINK program's block diagram interface. In the SIMULINK program's block diagram interface, various blocks are used to represent input data, output data, functions that act on the data and the like. Additionally, specialized blocks and/or other tooling for specific applications can be developed or purchased from third party vendors.

Once a model is developed using the SIMULINK program, another program called REAL-TIME WORKSHOP program or the REAL-TIME WORKSHOP EMBEDDED CODER program, also produced by MathWorks, can be used to convert the model into computer code. The REAL-TIME WORKSHOP program examines the model and determines what computer code needs to be generated to implant the model in software based on the different blocks used in the model. The REAL-TIME WORKSHOP program then generates the computer code. The computer code is typically ANSI compatible C code, although any computer code in any other programming languages such as Pascal, Cobol, Fortran and ADA, and the like can also be generated, depending on the capability of the code generator program and the needs of the user. Through the use of the SIMULINK program and the REAL-TIME WORKSHOP program, complex control systems can be modeled and computer code generated. Models and computer code generated from the models have been used in the avionics area to develop, among other software, software for flight control systems.

Software developed for use in the avionics area is preferably compliant with the guidance provided in DO-178B for satisfying FAA airworthiness requirements (note: outside the United States, guideline document ED12-B is used by the Joint Aviation Authority (JAA) and imposes similar requirements). RTCA document DO-178B outlines various guidelines, regulations, and qualifying procedures with which those developing software in the aviation area must comply. For example, section 6.3 of DO-178B states that software developed for avionic applications should be reviewed and analyzed. When code for an avionic application is developed using an automated tool such as the SIMULINK program and the REAL-TIME WORKSHOP program, RTCA document DO-178B states that the generated computer code should be reviewed and/or analyzed to see if any errors were introduced in the generation of the source code.

Currently, the guidelines of RTCA document DO-178B for source code (whether manually or automatically generated) are satisfied by having one or more persons manually review each and every line of the generated code. This manual review is a tedious, time consuming process that is compounded by the fact that the generated source code can contain thousands of lines of code, leading to review times of weeks and months. What is needed is a method and a system to automate the reviews of source code generated by an automatic code generator from a simulation model.

### SUMMARY OF THE INVENTION

In one embodiment of the present invention, a method for automatically reviewing the source code for a system where the source code is generated automatically from a model of the system is provided. In a first step, the model is read in and processed to determine the expected computer code based on the model. Next, the source code generated from the model is read in. The generated source code is compared to the expected source code to determine if the generated source code includes all the elements of the expected source code.

The method may also include comparing each of the lines of code in the generated computer code to the expected form to verify the generated code is in the proper format.

The method also may include comparing the generated computer code to the expected computer code to determine if the generated computer code includes any line of code not in the expected computer code.

The method may also include comparing the generated computer code to the expected computer code to determine if the lines of the generated computer code are in a logical order.

The method may also include comparing a header information section of the generated computer code to an expected header information section to determine if the header information section of the generated computer code matches the expected header information.

In another embodiment of the present invention, a computer-readable storage medium containing a set of instructions for verifying a generated computer code for a system is provided. The instruction set may include code that reads in a model file; code that determines an expected computer code based on the model file; code that reads in a generated computer file generated from the model file; and code that compares the generated computer code to the expected computer code to determine if the generated computer code includes all the lines of the expected computer code.

In yet another embodiment, a system for verifying the contents of a generated computer file is provided. The generated computer file generated from a model of the system. The system includes a processing means operable to compare the generated computer code with an expected computer code, the expected computer code determined by the processing means from the model. The system also includes a display coupled to the processing means, the display displaying the results of the comparisons.

### BRIEF DESCRIPTION OF THE INVENTION

The present invention will herein be described in conjunction with the following drawings and figures, wherein like numerals denote like elements and

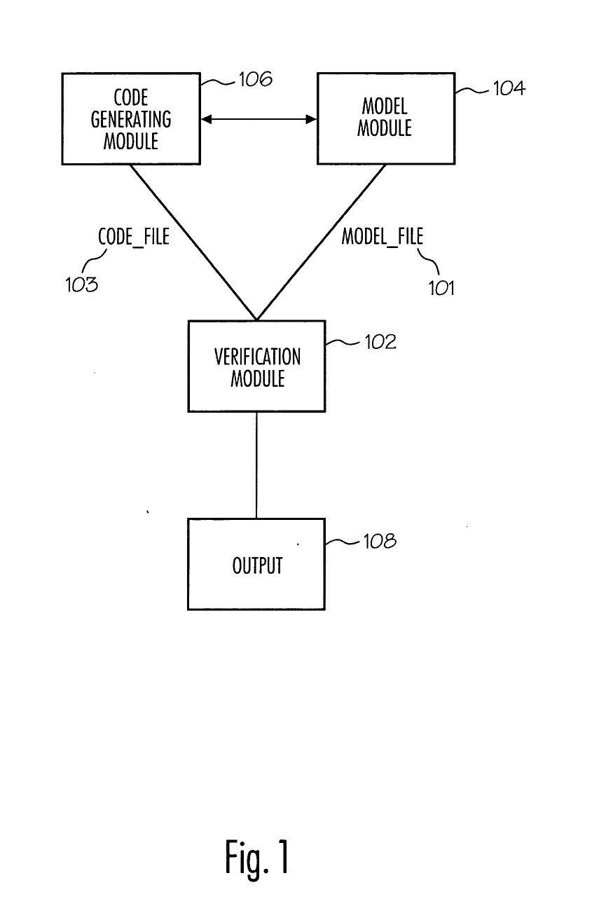

FIG. 1 is a block diagram of a system in accordance with the present invention;

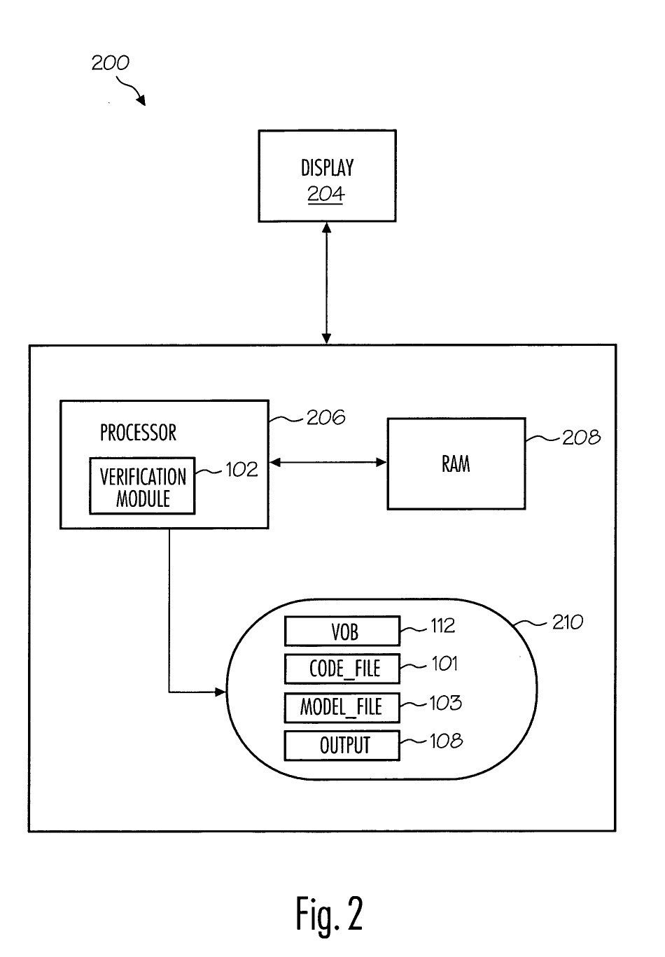

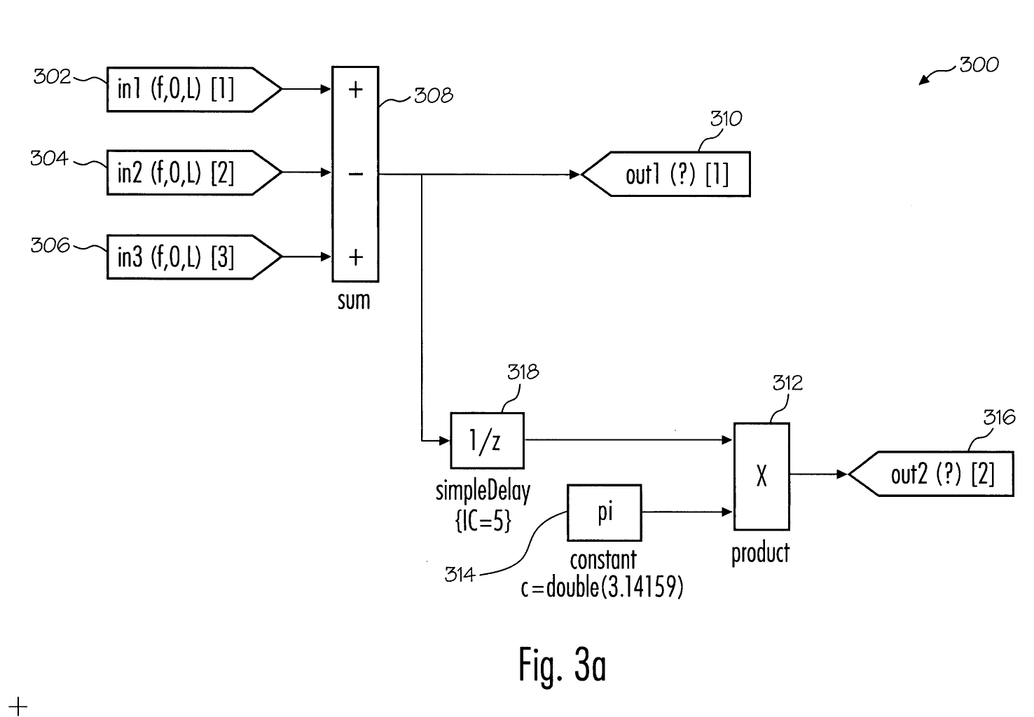

FIG. 2 is a block diagram of a computer for implanting the present invention;

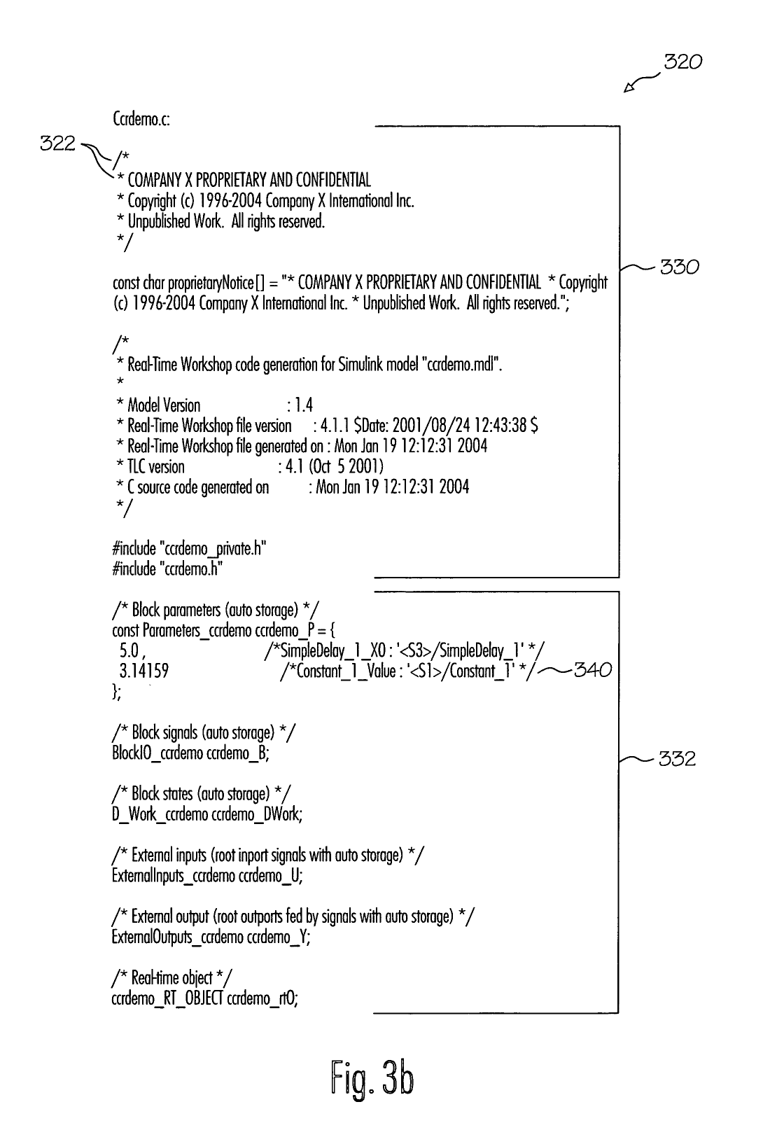

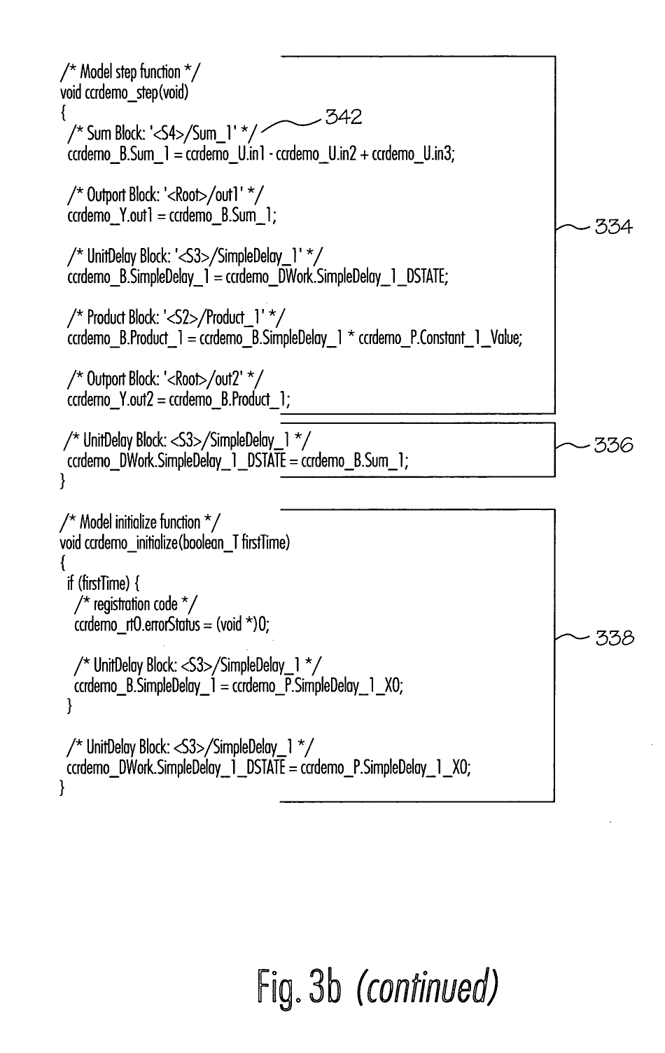

FIGS. 3a-3b illustrate an example of the verification of code generated by a graphical model; and,

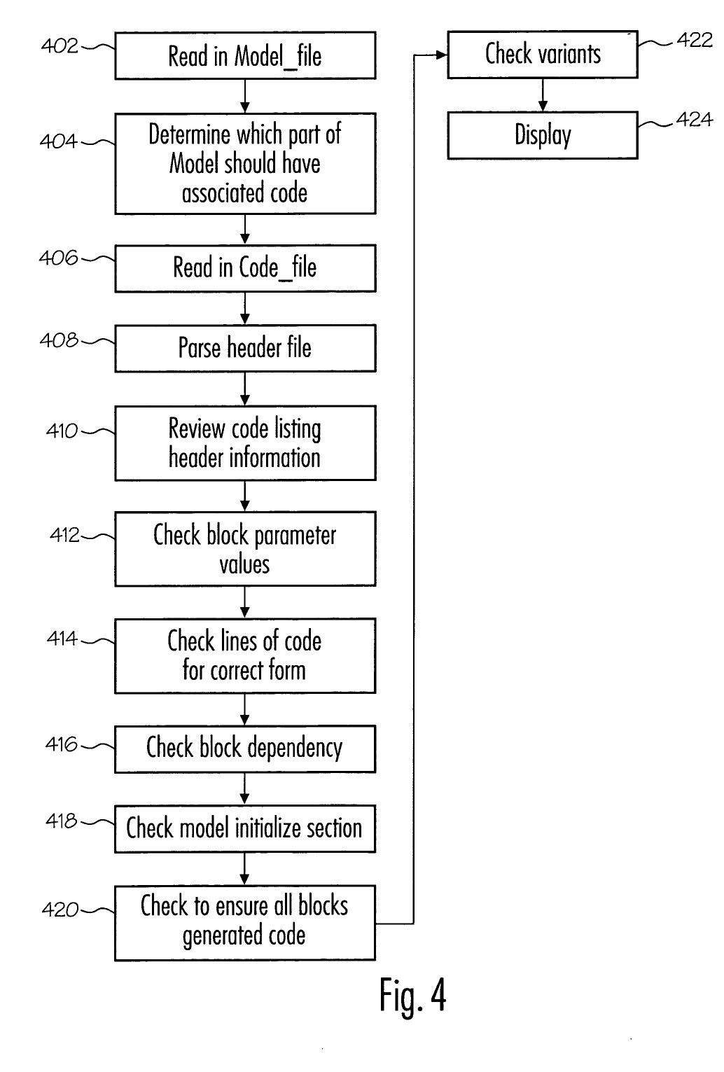

FIG. 4 is a flowchart of an exemplary method of performing the present invention.

### DETAILED DESCRIPTION OF THE INVENTION

The instant disclosure is provided to further explain in an enabling fashion methodologies and techniques for making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles can be implemented with or in software programs or instructions. It is expected that one of ordinary skill in the art, notwithstanding possibly significant effort and many design choices motivated by, for example, available time, current technology, and economic considerations, when guided by the concepts and principles disclosed herein will be readily capable of generating such software instructions and programs without undue experimentation.

FIGS. 1-4 illustrate a method and system for verifying computer source code generated by an automatic code generating program from a model developed using a computer modeling tool. As discussed previously, an example of an automatic code generator is MathWork's REAL-TIME WORKSHOP program, which generates source code from models developed using MathWork's MATLAB/SIMULINK programs. The discussion of these particular programs are for exemplary purposes only and the present invention can be used to verify computer code generated by any automatic code generator that generates code based on a model. Also, the present invention can be used to verify programming code generated in any programming language such as ADA, Fortran, C, Pascal and the like. The discussion of the use of any particular programming language is for exemplary purposes only.

In one embodiment of the present invention, a code verification module 102 verifies generated computer code versus a model from which the code was generated to ensure at least that all expected lines of code from the model are in the generated code, that there are no extraneous lines of code that can not be attributed to part of the model, that the lines of the code are written in proper order and that the code is in proper form. For example, in one embodiment, code verification module 102 receives, as input, a model_file 101 containing the simulation model of a system as produced by a model module 104. Code verification module 102 also receives one or more code_files 103 as produced by an autocode generator module 106 using the model developed from model module 104. The code verification module 102 checks the code in the code_file 103 as generated by the autocode generator module 106, as will be discussed in greater detail in conjunction with FIG. 4. An output 108 of the code verification module 102, which indicates whether the code has been successfully verified (or any relevant failure or warning messages), can then be displayed on a computer display 202, such as a computer monitor or other display device.

Code verification module 102 is, in one embodiment, software that compares generated computer code versus expected computer code to verify that no errors were introduced in generating the code. Code verification module 102 is, in one embodiment, executed on a processor 206 residing in a computer 200. Computer 200 and processor 206 can be any combination of a processor and computer capable of executing the code of the present invention. For example, processor 206 can be an INTEL processor, as manufactured by the Intel Corporation of Palo Alto, Calif., operating in a computer running the WINDOWS operating system, as sold by Microsoft Corp. of Redmond, Wash. Other combinations of processors and operating systems can also be used with the present invention, such as executing code verification module on an embedded processor.

Model module 104 is used to develop the model of the system. Typically model module 104 is used to form block diagram representations of a system. All of the inputs, outputs and operators on the input and outputs are typically represented by a series of interconnected blocks. An example of such a model is shown in FIG. 3a. The developed model is saved in a file, such as model_file 101, so that it can be used for both generation of computer code and the verification of that computer code. As discussed previously, SIMULINK is an example of a model module.

Autocode generator module 106 generates computer code from the model produced by model module 104. Autocode generator module 106 converts the blocks in the model to computer code and generates additional lines of code, such as those that declare variables needed for the program to properly execute. The generated code is code_file 103. Code_file 103 can be one or more files that collectively can be used to execute the generated program. An example of code_file 103 is illustrated in FIG. 3b. Real-Time Workshop, as discussed previously, is an example of an autocode generator module 106.

Code_file 103 and model_file 101 can be stored in a storage medium 210 that is accessible by the processor 206 executing the code verification module 102. Storage medium 210 can be any device capable of retaining a copy of a computer file for future retrieval, such as a floppy disk drive, an optical drive, a hard drive, a flash memory module and the like. Typically, storage medium 210 is located near processor 206, however, storage medium 210 can be located remotely from processor 206 and accessed via a computer network. Additional files that may be needed or produced by the present invention can also be stored in storage medium 210. These files include verification database 212 and the output file 108. The verification database 212 can be one or more databases containing information needed by the verification module 102 such as the format of the expected code for each possible block in a model. The output file 108 contains the results of the verification of the generated code that can be displayed on display 202 or any device capable of storing or displaying an output, such as a computer monitor, printer or storage device.

An exemplary model 300 is shown in FIG. 3a. Model 300 includes three inputs, in1 302, in2 304 and in3 306, which are algebraically summed in a sum block 308 to produce a first output 310. The algebraic sum of the three inputs is also multiplied in a product block 312 by a constant from constant block 314 to produce a second output 316. In this example, there is a delay block 318 between first output 310 and the product block 312. The delay block 318 receives a value (in this embodiment, the first output 310) and holds that value for one time step. The delay block 318 also has an initial condition (i.c.) associated with it. The initial condition is the value the delay block 318 will input into the product block 312 during the first pass through the system. In the example of FIG. 3a, the initial condition is set at 5. Therefore, in this example, the results of the initial summation is held for one time step and then in the second time step, the results of the summation in sum block 308 in that time step it is the first output 310. The second output 316 is the product of the first output 310 of the sum block 308 (first time step) multiplied by the constant 314. The following table illustrates exemplary inputs and outputs of model 300:

| Time | Input | Input | Input | First | Delay | Constant | Second |
|---|---|---|---|---|---|---|---|
| Step | 1 | 2 | 3 | Output | Value | value | Output |
| 1 | 2 | 1 | 6 | 7 | 5 | 3.14159 | 15.70795 |
| | | | | | (initial | | |
| | | | | | condition) | | |
| 2 | 6 | 3 | 7 | 10 | 7 | 3.14159 | 21.99113 |
| | | | | | (from first | | |
| | | | | | output | | |
| | | | | | of time | | |
| | | | | | step 1) | | |
| 3 | 12 | 14 | 4 | 2 | 10 | 3.14159 | 31.14159 |
| | | | | | (from first | | |
| | | | | | output | | |
| | | | | | of time | | |
| | | | | | step 2) | | |

The generated computer code 320, as seen in FIG. 3b consists of multiple lines of code 322. The computer code 320 is generated from the model 300 of FIG. 3a. The model 300 corresponds to the model_file 101 and the code of FIG. 3b corresponds to the code_file 103. In one embodiment, the computer code 320 can be divided up into different sections. For example, in FIG. 3b, computer code 320 includes a header section 330, a block parameter section 332, a model step section 334, a model update section 336 and a model initialize section 338. The header section 330 contains information about the program but no executable code. The block parameter section 332 sets forth the values of different constants used in the computer code 320. The model step section 334 contains all logical and algebraic algorithms within a model, as converted to computer code. The model update section 336 stores a blocks current value for use in a next cycle, such as holding an output value for a delay step. The model initialize section implements 338 a unit delay function. These sections, although shown in FIG. 3b, illustrate only one way to implement the computer code 320. Other arrangements of computer code 320 can also be used, including using the above section with one or more sections combined together or eliminated.

The following is an exemplary description of an embodiment of the method of the present invention. The parts of the method, while discussed in a certain order, can be done in a different order if logically possible. Also, depending on the various inputs to the method, part or all of a step or steps may be omitted. Turning to FIG. 4, in a first step 402, the model_file 101 as produced by the model module 104 is read by the code verification module 102 and parsed. In this step, the individual components of the model stored in model_file 101, corresponding, in one embodiment of the present invention, to a series of connected blocks, are analyzed. All information regarding the blocks of the model, such as any constant values associated with the block, the configuration of the blocks such as the number of inputs and outputs, the name and type of each block and specific information for each type of block is determined. Also, in this step, the model is traced though from each input to each output. The type of data inputted and outputted is stored. For example, in the example of FIG. 3a, the sum block 308 has three inputs; in1 302, in2 304, and in3 306. Sum block 308 receives in1 302 subtracts in2 304 from in1 302 and adds in3 306. Thus, the sum block is of the form +−+, with respect to the inputs. The configuration of sum block 308 is stored for future use. The information in one embodiment, is stored in storage medium 210.

Next, in step 404, the code verification module 102 determines which of the block(s) in the model should have lines of codes associated with them. Generally, blocks in a model that call for an action, such as summation blocks, blocks that provide inputs and blocks that provide outputs would have code associated with them. Other blocks in a model that merely serve to help organize a model or connect inputs and outputs in a model do not typically have codes associated with them. Blocks that require code are known, in one embodiment, as non-virtual blocks and those that require code are known as virtual blocks.

The code verification module 102 then reads in the code_file 103, in step 406. In one embodiment, the code_file 103 is comprised of at least two separate files: a c-code file containing the generated lines of code 322 and an h-code file, not pictured, known as the header file, that contains information needed for the compilation/linking of the generated lines of code 322 into an executable or some other compiler/linker output. During step 406, in one embodiment of the present invention, when the computer code 320 is generated, the code associated with the individual blocks are labeled using a shorthand notation such as <S#> where the # is as Arabic number uniquely assigned to a given block or system. The header file, in this embodiment, includes a mapping of the shorthand notation to the name of the block. For example, <S1> might be associated with <SumBlock>. Turning to FIG. 3b, in the code 320 there is a sumblock line 340 with the notation <s4>. The header file in this embodiment would have a mapping that would associate <s4> with the full name of the block <sumblock>. In step 406, the shorthand notations are replaced by the full name in order to make the comparison of computer code lines easier.

The header file is parsed in step 408 to determine the declared order and name of the input and/or output of each block, each parameter of the model, and the state structure in the model. The parsed header file is then compared against the model to ensure that the data type declared in the header file matches the data type used for each block in the model.

Next, in step 410, the code listing in the c-code file is reviewed. First, the header information (or initial information in the code) of the computer code file is reviewed. In one embodiment, the header information is stored in header section 330, as seen in FIG. 3b. The header information may include such information as a proprietary notice (such as “Company X Proprietary and Confidential”), the date and time the code was generated, etc. The header information is typically contained within comment lines of the code and may not be executable lines. For review purposes, the expected header information is compared to the actual header lines of code 322 to see if the information matches. The expected header information can be stored in the verification database 212. For example, if the expected header information is a copyright notice such as “Copyright (c) 1996-2004 X International, Inc.” that information can be stored as the expected header information. Then, when the lines of code 322 are being reviewed, the lines of code 322 are compared to the expected header information to see if there is a match.

In step 412, the block parameter values declared in the generated computer code are checked against the expected block parameters determined from the model to see if there is a match. In one embodiment, the parameter values are stored in the parameter section 324 of computer code 320. An example of such block parameters, in the current embodiment, is the “constant” block 314. In the model 300 of FIG. 3a, the constant block 314 has a value of 3.14159. When the generated computer code is generated from the model, the value of the constant block should appear in the code 320. In FIG. 3b, constant line 342 defines the constant variable as having the value of 3.14159. In this step, the generated computer code is checked to insure the declared value is assigned a value of 3.14159.

In step 414, the code verification module 102 checks to determine if all lines of code 322 within the computer code 320 matches the expected form for that line (in embodiments that separate the code into a model step section 334 and a model initialize section 338 this step can first be done on the model step section 334 and then can be done on the model initialize section 338 in a later step). This comparison is done by using a case-sensitive string comparison of the computer code program line versus an expected form for the block or command stored, in one embodiment, in the verification database 212 or similar structure and accessible by the code verification module 102. The verification database contains, for each possible command in the computer code, the proper, expected form of the command.

For example, the expected form for a product block may be:
<output1>=<input1><opr1><input2><opr2><input3> . . . <oprN><inputN>
   where <inputX> for x=1 to N are the inputs that will be operated on and <oprY> for Y=1 to N are the operators (either multiplication, *, or division, /).

In conjunction with the knowledge obtained from parsing the model_file 101 and the known format of each command or statement, the present invention can determine if a command or statement contained within the computer code 320 matches the proper form as expected by analyzing the model_file 101. For example, if the code verification module 102 was analyzing the model of FIG. 3a where the summation block is, from the model and knowledge of the proper syntax for a summation block, the expected line of code that should be generated from that block is:
example_B.sum_{—}1=example_U1.in1−example_U.in2+example_U.in3;

The actual line of code from the generated code 320 in FIG. 3b is then compared to the expected line. In this case, the generated line of code matches the expected line of code and the line of code passes verification. If, however, the generated line was:
example_B.sum1=example_U.in1+example_U.in2+example_U.in3;
   then the line from the computer code would not match, and an error would be generated, such as a message stating “error message” or “error condition”.

In step 416, proper block dependency is checked. As seen in FIG. 3a, the inputs 302, 304 and 306 must be summed before the result can be multiplied in the product block 316. In this step, the verification module 102 checks the generated computer code 320 to determine if the summation is done prior to finding the product. This verifies proper data flow and order dependency.

Next, in step 418, the generated code relating to the state of the program, if any, (in one embodiment code relating to the state of the system can be found in the model initialize section 338 and model update section 336) is checked to see if the expected lines of code were generated, and if the generated code matches the expected form of the code. If the expected code contains no states or updates, then these areas within the generated code may be verified to be blank or non-existent. That is, that there is no extraneous code. Alternatively, steps 416 and steps 418 may be combined as a single step.

In step 420, it is determined if all blocks in the model 300 that were expected to generate code, did indeed generate code that appears in computer code 320. When the model of model_file 101 was first analyzed, the information regarding which blocks would generate code was saved. When the code_file 103 is then examined, it is determined if each of the blocks that were expected to generate lines of code actually generated lines of code. Also the generated code is checked to see if all the lines of code 322 in the computer code 320 can be attributed to the model 300 (i.e. no extraneous lines of code).

An optional step 422 may be performed to ensure that any code or files specific to a variant of the autocode generator module 106 is checked. Different variants of a code generator might produce different files or specific functions unique to that embodiment. This step allows any variation that can be expected to be checked.

The result of the check is then displayed to the user, in step 424. This result can include a summary of any missing lines of code, any extra lines of code, any code that did not match the expected form, any code that did not have proper dependency and any other failure. If all lines within the code 320 pass, then an “All Pass” or similar message may be generated. That is to say, display to the user may be either positive, negative, or a combination.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

1. A method for verifying a generated computer code having a plurality of lines generated from a model of a system comprising:
processing the model to determine an expected computer code having a plurality of lines based on the model; and
comparing the generated computer code to the expected computer code to determine if the generated computer code includes all of the lines of the expected computer code.

2. The method of claim 1 further comprising the step of comparing each of the lines of the generated computer code to an expected form to verify each of the lines of the generated computer code is in a proper format.

3. The method of claim 1 further comprising the step of comparing the generated computer code to the expected computer code to determine if the generated computer code includes any line of code not in the expected computer code.

4. The method of claim 1 further comprising the step of comparing the generated computer code to the expected computer code to determine if the lines of the generated computer code are in a logical order.

5. The method of claim 1 further comprising the step of comparing a header information section of the generated computer code to an expected header information section to determine if the header information section of the generated computer code matches the expected header information.

6. The method of claim 1 further comprises comparing a generated declared variable section of the generated computer code to an expected declared variable section of an expected computer code to determine if the generated declared variables section matches the expected declared variable section.

7. A computer-readable storage medium containing a set of instructions for verifying a generated computer code having a plurality of lines, the generated computer code automatically generated from a model of a system, the set of instructions comprising:
code that reads in a model file;
code that determines an expected computer code having a plurality of lines based on the model file;
code that reads in the generated computer code; and
code that compares the generated computer code to the expected computer code to determine if the generated computer code includes all the lines of the expected computer code.

8. The medium of claim 7 wherein the set of instructions further comprises code that compares each of the lines of the generated computer code to an expected form.

9. The medium of claim 7 wherein the set of instructions further comprises code that compares the generated computer code to the expected computer code to determine if the generated computer code includes any line of code not in the expected computer code.

10. The medium of claim 7 wherein the set of instructions further comprises code that compares the generated computer code to the expected computer code to determine if the lines of the generated computer code are in a logical order.

11. The medium of claim 7 wherein the set of instructions further comprises code that compares a header information section of the generated computer code to an expected header information section to determine if the header information section of the generated computer code matches the expected header information.

12. A system for verifying the contents of a generated computer code generated from a model comprising:
a processor operable to compare the generated computer code with an expected computer code, the expected computer code determined by the processor from the model; and
a display coupled to the processor, the display displaying a result of the comparisons.

13. The system of claim 12 wherein the results of the comparison indicates if the generated computer code has all of the content of the expected computer code.

14. The system of claim 12 wherein the results of the comparison indicates if the generated computer code has any additional content not found in the expected computer code.

15. The system of claim 12 wherein the processor means is operable to compare each of the lines of code in the generated computer code to an expected form.

16. The system of claim 12 wherein the processor means is operable to compare the generated computer code to the expected computer code to determine if the generated computer code includes any line of code not in the expected computer code.

17. The system of claim 12 wherein the processor means is operable to compare the generated computer code to the expected computer code to determine if the lines of the generated computer code are in a logical order.

18. The system of claim 12 wherein the processor means is operable to compare a header information section of the generated computer code to an expected header information section stored in a database or stored via other means to determine if the header information section of the generated computer code matches the expected header information.

19. The system of claim 12 wherein the model is a model of an aircraft control system.

20. The system of claim 12 wherein the result of the comparison satisfies DO-178B.
